(19) United States
(12) Patent Application Publication
(10) Pub. No.: US 2026/0340468 A1
(43) Pub. Date: Oct. 29, 2026

(54) SWITCH MATRIX-BASED CONTROL AND READOUT ARCHITECTURE FOR SCALABLE MULTI-QUBIT QUANTUM SYSTEMS

(71) Applicant: Dell Products L.P., Round Rock, TX (US)

(72) Inventors: Tejinder Singh, Manotick (CA); Navjot Kaur Khaira, Manotick (CA)

(21) Appl. No.: 19/189,238

(22) Filed: Apr. 24, 2025

(51) Int. Cl. G06N 10/40; F25B 9/12; G06N 10/20

(52) U.S. Cl. CPC G06N 10/40; F25B 9/12; G06N 10/20

(57) ABSTRACT

The technologies described herein are generally directed towards controlling a signal splitter, a switch matrix and a multi-throw switch in a cryogenic microwave signal routing system and architecture. The signal splitter and switch matrix are controlled in a multiplexed fashion to manage analog waveform delivery to qubits under the control of classical logic. Similarly, multiplexed qubit readout is facilitated using multi-throw switch control. The multiplexed signal delivery to qubits, by controlling signal splitter state selection and switch matrix addressing, results in high-fidelity qubit control in large qubit arrays. Qubit readout can be accomplished via multi-throw switch state control, facilitating multiplexed signal readout from any selected qubit. Further, the system/architecture allows for obtaining telemetry data from individual qubits using the multi-throw switch, so that the system can adjust for variations in qubit parameters, ensuring optimal performance, while providing real-time feedback such as for calibration and error detection.

### BACKGROUND

As quantum computing systems transition from experimental few-qubit quantum systems to large-scale quantum processors, larger quantum computing systems call for different control architectures and supporting devices. For example, as quantum processors grow substantially with respect to the number of qubits therein, signal routing and readout systems become significant design considerations.

### BRIEF DESCRIPTION OF THE DRAWINGS

The technologies described herein are illustrated by way of example and not limited to the accompanying figures in which like reference numerals indicate similar elements and in which:

FIG. 1 is a representation of example switch matrix (SMTX) and a symbolic representation thereof useable in an example qubit control and addressing architecture, in accordance with various embodiments and implementations of the subject disclosure.

FIG. 2 is a representation of example signal splitter, a switch matrix and multi-throw switch integrated into an example qubit control and addressing architecture, in accordance with various embodiments and implementations of the subject disclosure.

FIG. 3 is a block diagram representation of an example qubit control and addressing architecture that includes a switch matrix for selectively coupling to qubits, in accordance with various embodiments and implementations of the subject disclosure.

FIG. 4A is an example timing sequences of gate operations on a single qubit, in accordance with various embodiments and implementations of the subject disclosure.

FIG. 4B is an example timing sequences of gate operations on two qubits, in accordance with various embodiments and implementations of the subject disclosure.

FIG. 5 is a representation of a hardware architecture responsible for routing signals to selected qubits (corresponding to FIG. 4A), in accordance with various embodiments and implementations of the subject disclosure.

FIG. 6 is a representation of a hardware architecture responsible for routing signals to two selected qubits (corresponding to FIG. 4B), in accordance with various embodiments and implementations of the subject disclosure.

FIG. 7A is an example timing sequences of gate operations on two qubits, in accordance with various embodiments and implementations of the subject disclosure.

FIG. 7B is an example timing sequence of a readout operation on a qubit, and routing the readout information to a classical control system (FIG. 9), in accordance with various embodiments and implementations of the subject disclosure.

FIG. 8 is a representation of a hardware architecture responsible for routing signals to two selected qubits (corresponding to FIG. 7A), in accordance with various embodiments and implementations of the subject disclosure.

FIG. 9 shows example time sequenced signal routing for qubit readout of one of the qubits using a multi-throw switch, in accordance with various embodiments and implementations of the subject disclosure.

FIG. 10 is a flow diagram showing example operations related to addressing a selected qubit based on controlling a signal splitter and a switch matrix, in accordance with various aspects and implementations of the subject disclosure.

### DETAILED DESCRIPTION

Various implementations and embodiments of the technologies described herein are generally directed towards a cryogenic microwave signal routing and qubit readout system and architecture using signal splitter, a switch matrix and a multi-throw switch. Described is a switch matrix-based architecture (SMTX) that significantly reduces the physical and thermal footprint typically used for qubit control and readout. The switch matrix-based architecture uses a single microwave photon source for multiple qubits through an addressable routing matrix, dynamically assigning input signals to designated qubits or readout nodes.

Note that traditional architectures use individual microwave sources and individual control lines for qubit manipulation and readout. This introduces complex wiring and high-power consumption, which hinders scalability.

By leveraging address line-based routing, the system and architecture described herein reduces the reliance on dedicated control lines and simplifies quantum processor scaling. Indeed, in existing quantum systems, each qubit is typically controlled and read out using its own dedicated microwave line, which runs from room temperature down through the stages of a dilution refrigerator to the qubit located at millikelvin temperatures. This approach, while effective for small-scale systems, creates significant challenges as the number of qubits increases, as each qubit uses a separate control line to deliver precise microwave pulses for gate operations and individual readout, leading to a rapid increase in the number of wires that pass through the refrigerator's thermal stages as the number of qubits increases. As quantum processors scale to thousands or millions of qubits, this traditional wiring scheme becomes unsustainable, both in terms of space within the cryostat and the complexity of managing large numbers of microwave lines while maintaining signal integrity and minimizing noise.

In contrast to traditional architectures, the architecture described herein streamlines the integration of classical and quantum components, ensuring low-latency, high-speed operations appropriate for maintaining qubit coherence. The scaling of superconducting quantum processors benefits from the significant reduction in the overhead associated with signal routing and control as described herein.

It should be understood that any of the examples and/or descriptions herein are non-limiting. Thus, any of the embodiments, example embodiments, concepts, structures, functionalities or examples described herein are non-limiting, and the technologies may be used in various ways that provide benefits and advantages in communications and computing in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some practical limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

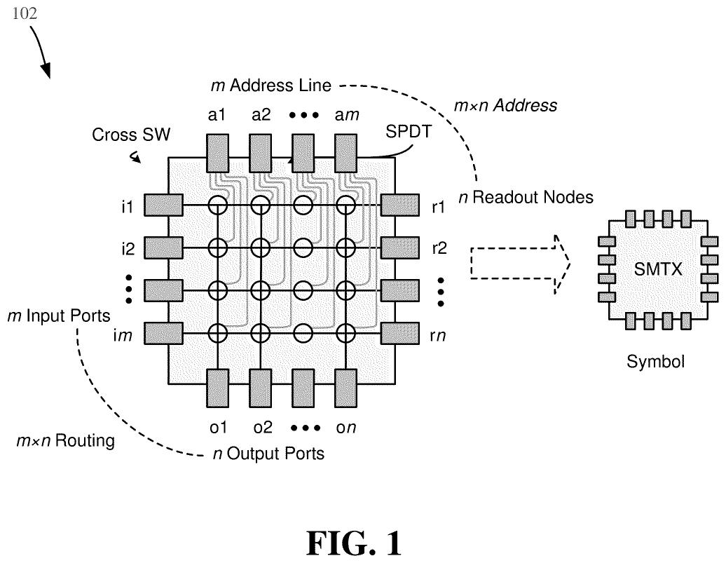

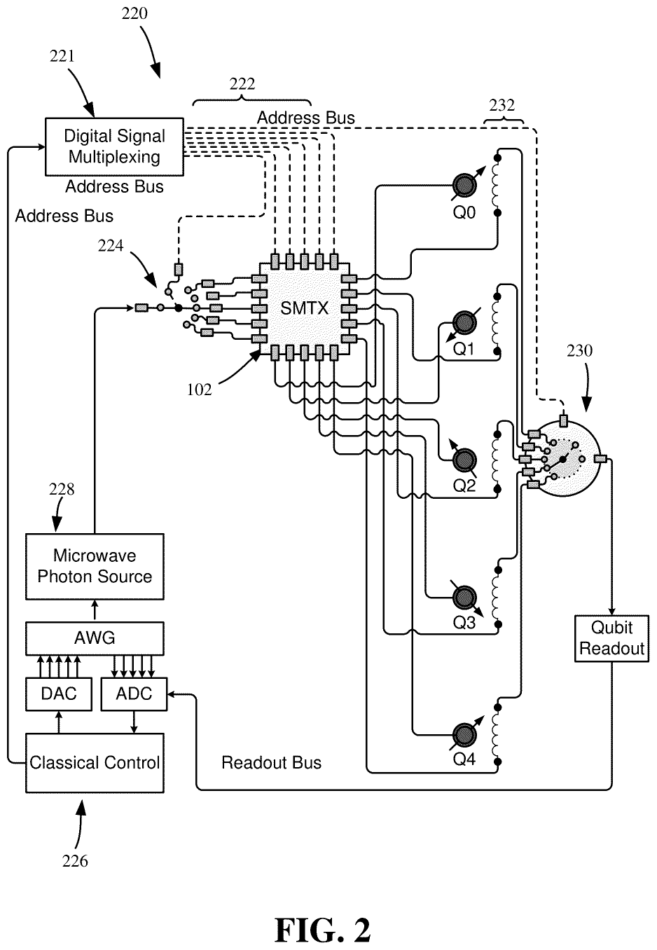

FIG. 1 shows a switch matrix (SMTX) 102 that, when implemented in the system and architecture 220 of FIG. 2, is configured to route microwave signals to one or more selected qubits based on digital addressing. The digital addressing lines needed for selecting the qubits as described herein are separate from the high-bandwidth analog control signals. The switch matrix 102 includes m input ports and n output and n readout ports which connect to multiple qubits.

As shown in FIG. 2, the routing decisions are controlled by digital signal multiplexing (block 221) coupled to digital address lines 222, allowing the switch matrix 102 to direct a single microwave photon source to one or multiple qubits, depending on the operations being performed as shown in the architecture 220. The readout from multiple-qubits Q0-Q5 (in this example) is managed by a signal splitter 224 that picks the signal from the qubit being readout to the analog-to-digital converter (ADC).

The system and architecture 220 addresses the limitations of current quantum control systems via switch-matrix based control system. The system and architecture 220 reduces the reliance on individual microwave photon sources for each qubit, instead enabling a shared set of waveform generators and converters to control multiple qubits. This both reduces the amount of hardware and simplifies control.

In particular, FIG. 2 shows the example architecture/system 220 for a cryogenic microwave signal routing with selective, multiplexed signal delivery to qubits, and switch-based selective readout of quantum state information from the qubits. The architecture features a cryogenic signal splitter 224 with respective throws coupled to respective inputs of the switch matrix (SMTX) 102. Together, the signal splitter 224 and switch matrix 102 route analog waveforms (microwave signals) to selected qubits (e.g., Q0-Q4 at 20 mK) under classical control (block 226).

The classical control (block 226) can be a high-performance cluster or server computing device, coupled for data output to the rest of the system via a digital-to-analog converter (DAC), and for input from the system via an analog-to-digital converter (ADC). One example output from the classical control (block 226) is to the arbitrary waveform generator (AWG) which provides the waveform to a microwave photon source 228 for outputting a microwave signal, via selected and controlled switches and splitter, to a selected qubit.

Also shown in FIG. 2 is a single-pole, multi-throw switch 230 coupled to inductors/resonators (collectively labeled 232) that are configured to read the qubits. Depending on the controlled address of the switch matrix 102, any qubit can be a selected qubit, coupled to its associated (proximate) inductor/resonator, for readout of quantum state information therefrom. Qubit readout/quantum state information is obtained by the classical control device 226 via the ADC. Note that amplifiers and the like are generally used for readout of the relatively weak qubit information.

To summarize thus far, the system/architecture 220 of FIG. 2 addresses the limitations of current quantum control systems by introducing a cryogenic microwave signal routing solution with multiplexed signal delivery to qubits. The system/architecture reduces the reliance on individual microwave photon sources for each qubit as in current quantum systems, instead enabling a shared set of waveform generators and converters to control multiple qubits. This both reduces hardware requirements and simplifies control.

Some benefits of the system 220 are obtained from the signal splitter 224 and the switch matrix 102, which route the microwave signals to selected qubits based on digital addressing. The signal splitter 224, which can use phase-change materials, is highly suitable for cryogenic operation, facilitating precise control over the amplitude and phase of the microwave signals directed to each qubit. Control of the signal splitter 224 facilitates selective routing of microwave signals between different input ports of the switch matrix, enabling the connection of one or more inputs to one or more outputs in a controlled manner.

Further, the system/architecture 220 allows fetching telemetry data from individual qubits using the controlled muti-throw switch 230, so that the system can adjust for variations in qubit parameters, ensuring optimal performance. This also provides real-time feedback for calibration and error detection.

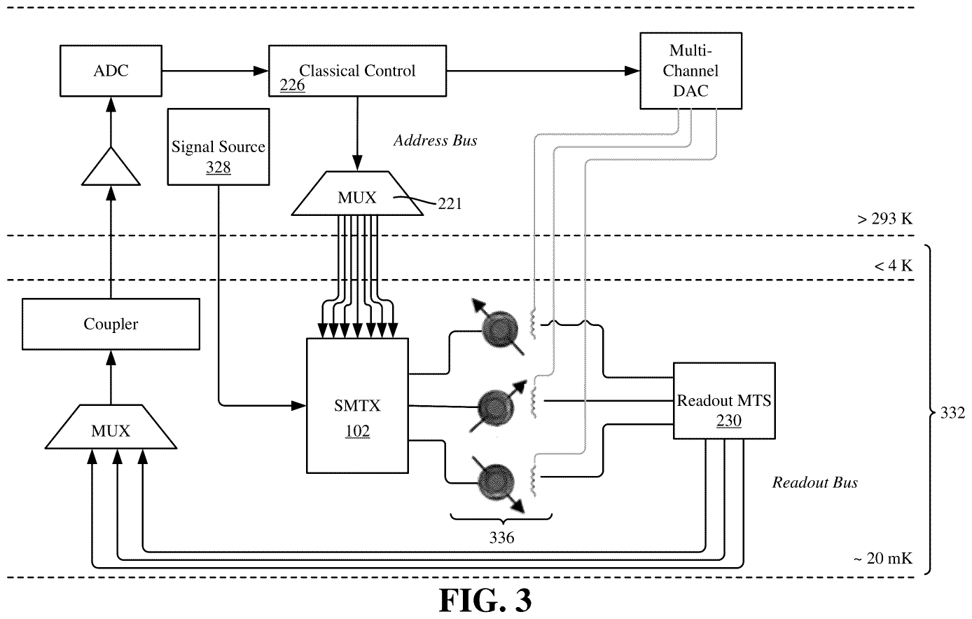

Given the large number of qubits and fast control requirements, parts of the control architecture are strategically placed at cryogenic temperatures, either on-chip or in close proximity thereto, using multichip modules and compact transmission lines. To balance the interconnect density, signal latency, and heat dissipation, the architecture is distributed across different temperature stages in a dilution refrigerator 332 as shown in FIG. 3. The signal source 328 (e.g., the microwave photon source 228 of FIG. 2) generates microwave pulses, which are routed through the signal splitter 224 to one or more of the inputs of the switch matrix 102 to selectively target specific qubits (collective labeled 336) for quantum gate operations. The signal splitter 224 and the switch matrix 102 are positioned near the qubits 336, as this minimizes the latency and synchronization issues that arise when signal travels over distances comparable to the wavelength of the control signals. The digital signal multiplexing 221/address bus 222, controlled by classical electronics at room temperature (around 293 K) determines which qubits are addressed. The readout process is conducted through the separate readout multi-throw switch 230, and the output is sent by the readout bus to the ADC for conversion into digital signals, to the classical control system 228.

In general, the system operates by breaking down quantum algorithms into sequences of universal quantum gates, using repeated single-and two-qubit operations. At the physical qubit level, these gate operations are executed through calibrated microwave waveforms applied to specific qubits or pairs of qubits during each clock cycle, as determined by the quantum program (e.g., algorithm) that is running. The quantum program is executed by the digital address bus, selecting qubits and qubit pairs to receive the appropriate waveform at the correct clock cycle. Similarly, qubit readout is performed by selecting specific qubits through the digital bus, in which the qubits are connected to multiplexing devices and analog readout circuitry.

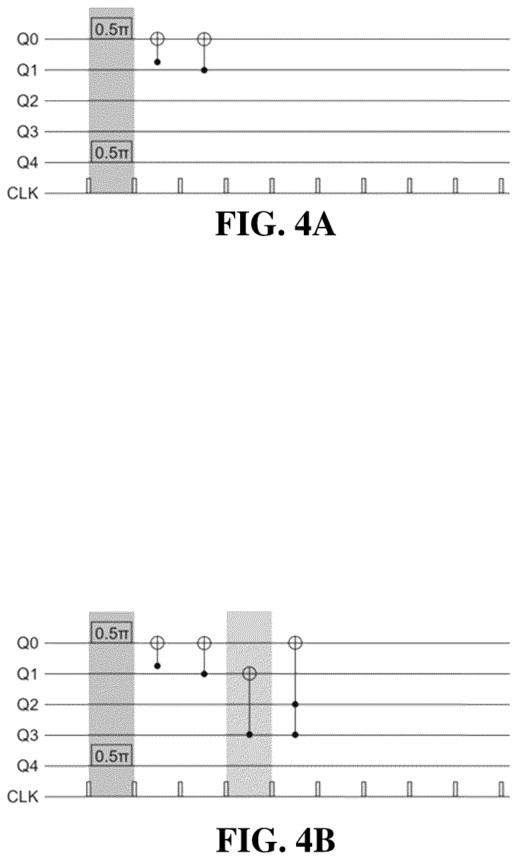

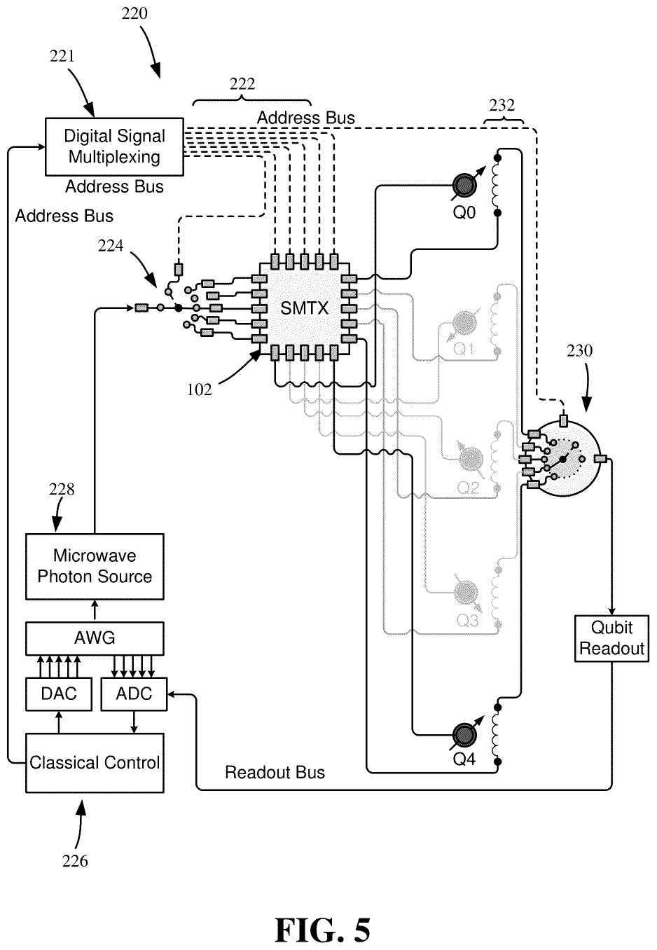

Examples of such quantum operations are shown in FIG. 4A-8. For operations on a specific qubit, as shown in FIG. 4A, the switch matrix 102 directs the signal from the microwave photon source 228 to the appropriate output port connected to the qubit Q0. More particularly, FIG. 4A shows the timing diagram of the gate operations applied to Q0 and Q4. FIG. 5 shows the hardware implementation of the same operations. More particularly FIG. 4A shows the timing sequence of single-qubit gate operations on Q0 and Q4 in the shaded region. The signal splitter state and the switch matrix addressing, as controlled by the computing device via digital signal multiplexing 221 is responsible for routing signals to the selected qubits Q0 and Q4, ensuring efficient execution of quantum gates with minimal hardware resources. For example, in FIG. 5, the signal splitter 224 is controlled to couple the microwave signal from its pole contact to the throw contacts coupled to the switch matrix inputs. In turn, the switch matrix 102 couples one of its output ports to the qubit Q0 and another one of its output ports to the qubit Q4.

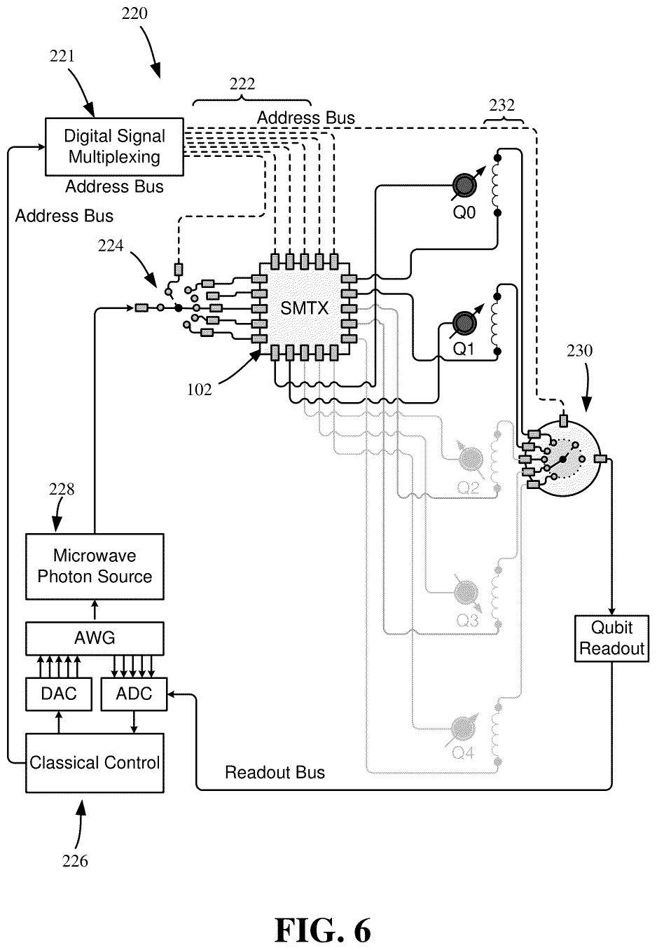

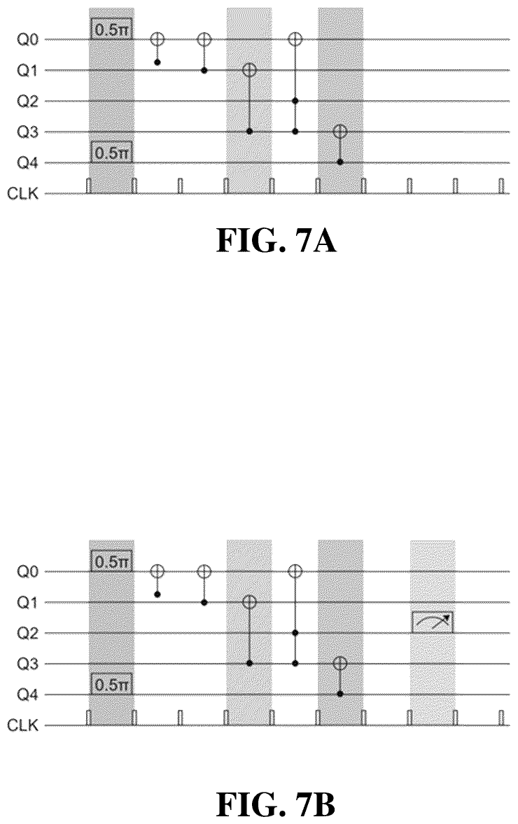

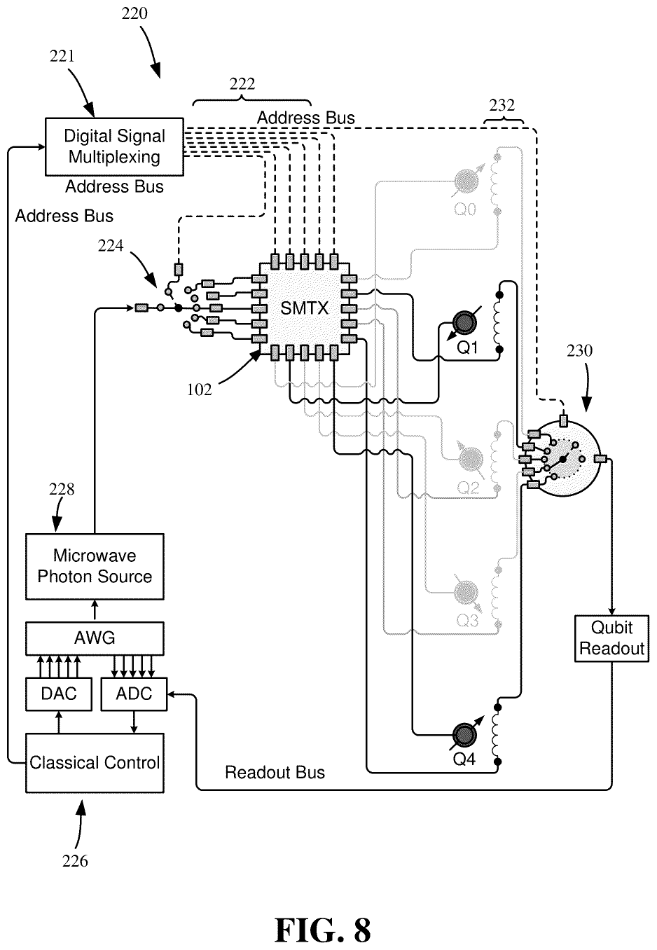

For two-qubit operations as shown in FIGS. 4B and 6, and in FIGS. 7A and 8, the switch matrix 102 is controlled to simultaneously route signals to the corresponding output ports coupled to the qubits, enabling multi-qubit gate operations.

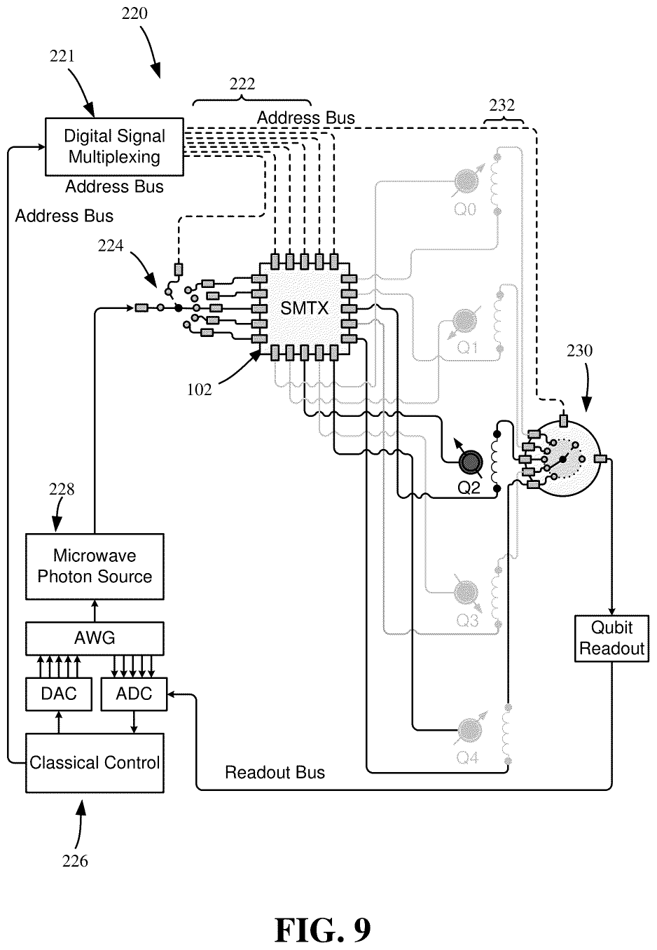

With respect to readout from the qubits, FIG. 7B shows the timing sequence of a readout operation on the qubit Q2 (highlighted in the rightmost shaded region). FIG. 9 shows the hardware architecture responsible for reading out signal from selected qubit Q2, then routing it to classical control after performing analog-to-digital signal conversion. More particularly, as shown in FIG. 9, the switch matrix 102 and the multi-throw switch 230 are controlled to connect the readout node (the qubit's associated inductor/resonator) to the corresponding qubit Q2, and from there to the classical computer via the ADC.

As can be seen via FIG. 4A-8, a microwave signal can be routed to any selected qubit or qubits, and a readout can be obtained from any selected qubit.

Although the technologies described herein are not limited to any type of switch, other than switch types with suitable switching speed and cryogenic usage properties, as mentioned, one suitable type of switch for cryogenic usage is based on phase change materials (PCMs). Phase change materials, which are used in phase change switches, are typically alloys of germanium (Ge), antimony (Sb), and/or tellurium (Te), and have the property to reversibly switch between amorphous and crystalline states when subjected to controlled electrical heating, which alters their electrical resistance. The name ‘phase change’ is based on a phase change switch's ability to switch between two states, and the controllability allows controlled electrical coupling or decoupling of components coupled to the switch contacts. Moreover, a phase change material device can latch into either state (ON or OFF) without requiring continuous power, making them energy-efficient and suitable for cryogenic environments where power dissipation is a significant consideration.

One or more example implementations can be embodied in a system. The system can include a signal splitter, including a pole coupled to a microwave photon source, respective throws coupled to respective input ports of a switch matrix, and a control input coupled to a computing device, the computing device configured to output switch signal data to the control input to select which of the respective throws is coupled to the pole. The switch matrix can include respective address contacts coupled to an address bus of the computing device via a digital signal multiplexer controlled by the computing device, and respective output ports coupled to respective qubits. To couple a microwave signal from the microwave photon source to interact with a selected qubit of the respective qubits, the computing device controls the signal splitter to couple the microwave signal to a selected input port of the respective input ports of the switch matrix, and to couple a respective output port of the respective output ports to a selected qubit of the respective qubits.

At least one of the signal splitter or the switch matrix can be deployed in a dilution refrigerator to operate at at least one cryogenic temperature.

The switch matrix can include respective readout ports coupled to respective readout resonators inductively coupled to the respective qubits, the respective readout resonators can include respective first contacts coupled to the respective readout ports of the switch matrix, respective second contacts, and respective first inductors coupled between the respective first contacts and the respective second contacts, and the computing device can control the switch matrix to couple a selected readout port of the respective readout ports to a first contact of the respective first contacts of a selected readout resonator of the respective readout resonators, corresponding to the selected qubit, to obtain a readout of qubit information of the selected qubit from the selected readout resonator via a second contact of the respective second contacts of the selected readout resonator.

The readout of the selected qubit can include telemetry data to facilitate at least one of: calibration or error detection by the computing device with respect to the selected qubit.

The pole can be a first pole, the respective throws can be respective first throws, the control input can be a first control input, the switch signal data can be first switch signal data, and the system further can include a multi-throw switch that can include a second pole coupled to the computing device via readout circuitry, respective second throws coupled to the respective second contacts of the respective readout resonators, and a second control input coupled to the computing device; the computing device can be configured to output second switch signal data to the second control input to select which of the respective second throws can be coupled to the readout circuitry via the second pole.

The first control input can be coupled to the computing device via a first control line of the address bus via the digital signal multiplexer, and the second control input can be coupled to the computing device via a second control line of the address bus via the digital signal multiplexer,

The readout circuitry can be coupled to the computing device via an analog-to-digital controller.

The selected qubit can correspond to a quantum gate for execution of part of a quantum program.

The microwave signal can be a first microwave signal, the selected qubit can be a first selected qubit that corresponds to a first quantum gate for execution of a first part of a quantum program in a first timeframe, and the computing device further can control the signal splitter and the switch matrix to couple a second microwave signal to a second selected qubit that corresponds to a second quantum gate for execution of a second part of the quantum program in a second timeframe.

The system further can include an arbitrary waveform generator coupled to the computing device via a digital-to-analog controller; the computing device can be configured to control the arbitrary waveform generator to generate a waveform, and the microwave signal can be based on the waveform.

The selected output port of the switch matrix can be a first selected output port, the selected qubit can be a first selected qubit, the computing device can control the switch matrix to couple the selected input port to a second selected output port of the switch matrix in conjunction with the first selected output port being coupled to the selected input port; the second selected output port can be coupled to a second selected qubit.

The first selected qubit can correspond to a first quantum gate for execution of part of a quantum program in a clock cycle timeframe, and the second selected qubit can correspond to a second quantum gate for execution of the part of the quantum program in the clock cycle timeframe.

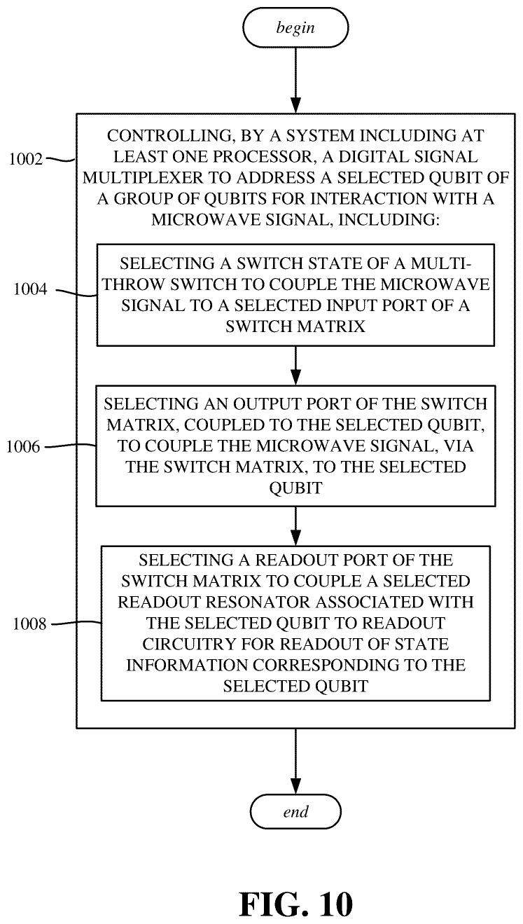

One or more example embodiments, implementations, and/or operations, such as corresponding to example operations of a method, can be represented in FIG. 10. Example operation 1002 represents controlling, by a system comprising at least one processor, a digital signal multiplexer to address a selected qubit of a group of qubits for interaction with a microwave signal, which includes example operations 1004, 1006 and 1008. Example operation 1004 represents selecting a switch state of a signal splitter to couple the microwave signal to a selected input port of a switch matrix. Example operation 1006 represents selecting an output port of the switch matrix, coupled to the selected qubit, to couple the microwave signal, via the switch matrix, to the selected qubit. Example operation 1008 represents selecting a readout port of the switch matrix to couple a selected readout resonator associated with the selected qubit to readout circuitry for readout of state information corresponding to the selected qubit.

The switch state can be a first switch state, and controlling the digital signal multiplexer further can include selecting a second switch state of a multi-throw switch to couple the selected readout resonator associated with the selected qubit to the system for the readout of the state information corresponding to the selected qubit.

The microwave signal can be a first microwave signal having a first amplitude and a first phase, and further operations can include obtaining, by the system, the state information corresponding to the selected qubit, determining, by the system based on the readout of the state information, a second amplitude and a second phase of a second microwave signal, and controlling, by the system, the digital signal multiplexer to address the selected qubit for interaction with the second microwave signal, comprising selecting the output port to couple the second microwave signal to the selected qubit.

The microwave signal can be a first microwave signal, the switch state of the signal splitter to couple the microwave signal to the selected input port of the switch matrix can be a first switch state, the selected input port can be a first selected input port, the selected output port can be a first selected output port, and further operations can include controlling, by the system, the digital signal multiplexer to address a second selected qubit of the group of qubits for interaction with a second microwave signal, which can include selecting a second switch state of the signal splitter to couple a second microwave signal to a second selected input port of the switch matrix, and selecting a second selected output port of the switch matrix, coupled to the second selected qubit, to couple the second microwave signal, via the switch matrix, to the second selected qubit.

One or more example implementations can be embodied in a system. The system can include a computing device, a multiplexer coupled to the computing device and coupled to a signal splitter coupled to a microwave photon source via a first pole, a switch matrix including respective input ports coupled to respective first throws of the signal splitter, address control ports coupled to the multiplexer, and respective output ports coupled to respective qubits. The system can include a multi-throw switch coupled to the computing device via a second pole and coupled to the respective readout resonators associated with the respective qubits via respective second throws. The computing device can be configured to control the multiplexer to control the signal splitter to couple the microwave photon source to a respective input port of the respective input ports of the switch matrix, couple a respective output port of the respective output ports of the switch matrix to a respective qubit, and control the multi-throw switch to couple a respective readout resonator of the respective readout resonators to the computing device for readout of qubit-related information from the respective qubit associated with the respective resonator.

The readout of the qubit-related information can include at least one of: telemetry data or qubit state data.

The respective qubit can correspond to a quantum gate for execution of part of a quantum program.

The respective qubit can be a first respective qubit, the quantum gate can be a first quantum gate, the part of a quantum program can be a first part, and the system further can include a second respective qubit that corresponds to a second quantum gate for execution of a second part of the quantum program.

As can be seen, the technologies described herein integrate signal splitter and a switch matrix, which can be deployed at cryogenic temperatures, into a qubit control system, reducing the need for separate control and readout lines for each qubit. This scalable approach consolidates microwave photon source routing, significantly decreasing the system's complexity. The system and architecture include digital signal multiplexing for precise selection of qubits using address buses. This approach, along with the signal splitter and the switch matrix, significantly reduces the number of physical control lines needed. Further, the system and architecture integrate a telemetry data collection and feedback system to allow for real-time calibration and error detection during qubit operations.

Unlike current quantum systems which use dedicated microwave source and control lines for each qubit, the switch matrix-based architecture enables flexible routing of microwave signals from a single source to any qubit or readout node, providing a dynamic, reconfigurable control architecture. The use of address lines enables the fast, real-time selection of qubits for operations and readout. The switch matrix-based architecture eliminates the need for dedicated control lines and multiple microwave sources for each qubit. This approach consolidates the control and readout system of multi-qubit systems. Further, the switch matrix-based architecture can scale efficiently to support large number of qubits without a proportional increase in system complexity, physical and thermal footprint.

What has been described above includes mere examples. It is, of course, not possible to describe every conceivable combination of components, materials or the like for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over other technology found in the marketplace, or to enable others of ordinary skill in the art to understand the embodiments disclosed herein.

What is claimed is:

1. A system, comprising:
a signal splitter, comprising:
a pole coupled to a microwave photon source,
respective throws coupled to respective input ports of a switch matrix, and
a control input coupled to a computing device, the computing device configured to output switch signal data to the control input to select which of the respective throws is coupled to the pole; and
the switch matrix, comprising:
respective address contacts coupled to an address bus of the computing device via a digital signal multiplexer controlled by the computing device, and
respective output ports coupled to respective qubits,
wherein, to couple a microwave signal from the microwave photon source to interact with at least one selected qubit of the respective qubits, the computing device controls the signal splitter to couple the microwave signal to a selected input port of the respective input ports of the switch matrix, and to couple a respective output port of the respective output ports to the at least one selected qubit of the respective qubits.

2. The system of claim 1, wherein at least one of the signal splitter or the switch matrix are deployed in a dilution refrigerator to operate at at least one cryogenic temperature.

3. The system of claim 1, wherein the switch matrix comprises respective readout ports coupled to respective readout resonators inductively coupled to the respective qubits, the respective readout resonators comprising respective first contacts coupled to the respective readout ports of the switch matrix, respective second contacts, and respective first inductors coupled between the respective first contacts and the respective second contacts, and wherein the computing device controls the switch matrix to couple a selected readout port of the respective readout ports to a first contact of the respective first contacts of a selected readout resonator of the respective readout resonators, corresponding to the at least one selected qubit, to obtain a readout of qubit information of the at least one selected qubit from the selected readout resonator via a second contact of the respective second contacts of the selected readout resonator.

4. The system of claim 3, wherein the readout of the selected qubit comprises telemetry data to facilitate at least one of: calibration or error detection by the computing device with respect to the selected qubit.

5. The system of claim 3, wherein the pole is a first pole, wherein the respective throws are respective first throws, wherein the control input is a first control input, wherein the switch signal data is first switch signal data, and further comprising:
a multi-throw switch, comprising:
a second pole coupled to the computing device via readout circuitry,
respective second throws coupled to the respective second contacts of the respective readout resonators, and
a second control input coupled to the computing device, the computing device configured to output second switch signal data to the second control input to select which of the respective second throws is coupled to the readout circuitry via the second pole.

6. The system of claim 5, wherein the first control input is coupled to the computing device via a first control line of the address bus via the digital signal multiplexer, and wherein the second control input is coupled to the computing device via a second control line of the address bus via the digital signal multiplexer.

7. The system of claim 3, wherein the readout circuitry is coupled to the computing device via an analog-to-digital controller.

8. The system of claim 1, wherein the at least one selected qubit corresponds to a quantum gate for execution of part of a quantum program.

9. The system of claim 8, wherein the microwave signal is a first microwave signal, wherein the at least one selected qubit comprises a first selected qubit that corresponds to a first quantum gate for execution of a first part of a quantum program in a first timeframe, and wherein the computing device further controls the signal splitter and the switch matrix to couple a second microwave signal to a second selected qubit of the at least one selected qubits that corresponds to a second quantum gate for execution of a second part of the quantum program in a second timeframe.

10. The system of claim 1, further comprising an arbitrary waveform generator coupled to the computing device via a digital-to-analog controller, wherein the computing device is configured to control the arbitrary waveform generator to generate a waveform, and wherein the microwave signal is based on the waveform.

11. The system of claim 1, wherein the selected output port of the switch matrix is a first selected output port, wherein the at least one selected qubit is a first qubit, wherein the computing device controls the switch matrix to couple the selected input port to a second selected output port of the switch matrix in conjunction with the first selected output port being coupled to the selected input port, and wherein the second selected output port is coupled to a second selected qubit of the at least one selected qubits.

12. The system of claim 11, wherein the first selected qubit corresponds to a first quantum gate for execution of part of a quantum program in a clock cycle timeframe, and the second selected qubit corresponds to a second quantum gate for execution of the part of the quantum program in the clock cycle timeframe.

13. A method, comprising:
controlling, by a system comprising at least one processor, a digital signal multiplexer to address a selected qubit of a group of qubits for interaction with a microwave signal, comprising:
selecting a switch state of a signal splitter to couple the microwave signal to a selected input port of a switch matrix;
selecting an output port of the switch matrix, coupled to the selected qubit, to couple the microwave signal, via the switch matrix, to the selected qubit; and
selecting a readout port of the switch matrix to couple a selected readout resonator associated with the selected qubit to readout circuitry for readout of state information corresponding to the selected qubit.

14. The method of claim 13, wherein the switch state is a first switch state, and wherein the controlling of the digital signal multiplexer further comprises selecting a second switch state of a multi-throw switch to couple the selected readout resonator associated with the selected qubit to the system for the readout of the state information corresponding to the selected qubit.

15. The method of claim 14, wherein the microwave signal is a first microwave signal having a first amplitude and a first phase, and further comprising,
obtaining, by the system, the state information corresponding to the selected qubit;
determining, by the system based on the readout of the state information, a second amplitude and a second phase of a second microwave signal; and
controlling, by the system, the digital signal multiplexer to address the selected qubit for interaction with the second microwave signal, comprising selecting the output port to couple the second microwave signal to the selected qubit.

16. The method of claim 13, wherein the microwave signal is a first microwave signal, wherein the switch state of the signal splitter to couple the microwave signal to the selected input port of the switch matrix is a first switch state, wherein the selected input port is a first selected input port, wherein the selected output port is a first selected output port, and further comprising:
controlling, by the system, the digital signal multiplexer to address a second selected qubit of the group of qubits for interaction with a second microwave signal, comprising:
selecting a second switch state of the signal splitter to couple a second microwave signal to a second selected input port of the switch matrix; and
selecting a second selected output port of the switch matrix, coupled to the second selected qubit, to couple the second microwave signal, via the switch matrix, to the second selected qubit.

17. A system, comprising:
a computing device;
a multiplexer coupled to the computing device, and coupled to:
a signal splitter coupled to a microwave photon source via a first pole;
a switch matrix comprising respective input ports coupled to respective first throws of the signal splitter, address control ports coupled to the multiplexer, and respective output ports coupled to respective qubits; and
a multi-throw switch coupled to the computing device via a second pole, and coupled to the respective readout resonators associated with the respective qubits via respective second throws, the computing device configured to control the multiplexer to:
control the signal splitter to couple the microwave photon source to a respective input port of the respective input ports of the switch matrix;
couple at least one respective output port of the respective output ports of the switch matrix to at least one respective qubit, and
control the multi-throw switch to couple a respective readout resonator of the respective readout resonators to the computing device for readout of qubit-related information from the respective qubit associated with the respective resonator.

18. The system of claim 17, wherein the readout of the qubit-related information comprises at least one of: telemetry data or qubit state data.

19. The system of claim 17, wherein the respective qubit corresponds to a quantum gate for execution of part of a quantum program.

20. The system of claim 19, wherein the respective qubit is a first respective qubit, wherein the quantum gate is a first quantum gate, wherein the part of a quantum program is a first part, and further comprising a second respective qubit that corresponds to a second quantum gate for execution of a second part of the quantum program.
